(19) United States
(12) Patent Application Publication
(10) Pub. No.: US 2019/0043389 A1
(43) Pub. Date: Feb. 7, 2019

(54) SHIPPING AND STORAGE CONTAINER LOCKING UNIT

(71) Applicants: SCOTT ARNOLD MELGAR, CANTON, MS (US); BERNARDO FRANCISCO VIDES RAMIREZ, GUATEMALA CITY (GT)

(72) Inventors: SCOTT ARNOLD MELGAR, CANTON, MS (US); BERNARDO FRANCISCO VIDES RAMIREZ, GUATEMALA CITY (GT)

(21) Appl. No.: 16/017,287

(22) Filed: Jun. 25, 2018

Related U.S. Application Data
(60) Provisional application No. 62/523,813, filed on Jun. 23, 2017.
(60) Provisional application No. 62/608,454, filed on Dec. 20, 2017.

(51) Int. Cl. G09F 3/03; B65D 55/02

(52) U.S. Cl. CPC G09F 3/037; B65D 55/02

(57) ABSTRACT

An apparatus for securing and locking shipping and storage totes and containers. An elongated locking strip with an insertion or pull end, a stop tab end, and a medial compression locking element is inserted at the insertion end into and through matching holes or slots in the lid or top of the tote or storage container, The strip is pulled so that the compression locking element passes through the holes or slots, with the stop tab end preventing the strip from completely passing through. Once in place, the configuration of the compression locking element prevents the apparatus from being pulled back through the holes or slots in reverse, thereby securing the top or lid, or portion of the top or lid, to the body of the container or tote. To open the container, the stop tab is removed, such as by twisting or cutting.

This application claims benefit of and priority to U.S. Provisional Application No. 62/523,813, filed Jun. 23, 2017, and U.S. Provisional Application No. 62/608,454, filed Dec. 20, 2017, and is entitled to the benefit of those filing dates for priority. The specification, figures, and complete disclosures of U.S. Provisional Applications Nos. 62/523,813 and 62/608,454 are incorporated herein by specific reference for all purposes.

### FIELD OF INVENTION

This invention relates to a system and apparatus for securing and locking shipping and storage totes and containers.

### SUMMARY OF INVENTION

In various exemplary embodiments, the present system comprises an apparatus for securing and locking shipping and storage totes and containers. The apparatus is configured to be quickly and easily inserted into matching holes or slots in the shipping tote or storage container, such as corresponding holes or slots in the lid or top and the side or rim, or a security or restraint port, thereby preventing the tote or container from being easily opened. The apparatus may be made of any suitable material, including, but not limited to, plastic.

In several exemplary embodiments the locking apparatus comprises an elongated plastic strip with an insertion or pull end, a stop tab end, and a compression locking element medially disposed therebetween. The insertion end is inserted into and through the matching holes or slots in the lid or top of the tote or storage container, and then used to pull the compression locking element through the holes or slots. The stop tab end prevents the apparatus from continuing to be pulled through the holes or slots. Once in place, the configuration of the compression locking element prevents the apparatus from being pulled back through the holes or slots in reverse, thereby securing the top or lid, or portion of the top or lid, to the body (e.g., side or rim) of the container or tote. To open the container, the stop tab is removed, e.g., twisted off, torn off, cut off, or the like.

The stop tab element provides various levels of safety tamper-evidence security (e.g., the breaking of the apparatus by removal of the stop tab demonstrates that the container or tote has been potentially opened), depending on the application. For light duty applications, the stop tab can be broken off or twisted off easily. The section of the strip proximate the stop tab may be perforated, have one or more holes therein, or be thinner in thickness or width, or combinations thereof, to facilitate removal. The stop tab also may be independent of the remaining components of the apparatus (as opposed to be integrated therewith), and attachable and detachable. For heavier duty applications, or applications that require a higher level of security, the stop tab and adjacent strip may be thickened, making it increasingly harder to remove the stop tab, or requiring the apparatus to be cut.

In several embodiments, the compression locking element comprises one or more angled extensions (or “hooks”) extending from the sides, with an elongated opening therebetween. This configuration allows the angled extensions to be pushed inwards when passing through the holes or openings, and expand outwards when completely pulled through. The angled extensions are angled to promote the compression when passing through, and to prevent pulling of the apparatus through the holes or openings in reverse.

### BRIEF DESCRIPTION OF THE DRAWINGS

FIGS. 1A-B show examples of an apparatus in accordance with exemplary embodiments of the present invention.

FIGS. 2-9 show views of the apparatus in use with a container or tote.

FIGS. 10-20 show additional embodiments of the apparatus.

FIGS. 21A-F show views of the apparatus in use with a container or tote.

FIGS. 22-40 show additional embodiments of the apparatus with different configurations of compression locking elements.

### DETAILED DESCRIPTION OF EXEMPLARY EMBODIMENTS

In various exemplary embodiments, the present system comprises an apparatus 2 for securing and locking shipping and storage totes and containers 50. The apparatus 2 is configured to be quickly and easily inserted into matching holes or slots 52 in the shipping tote or storage container 50, such as corresponding holes or slots in the lid or top and the side or rim, or a security or restraint port, thereby preventing the tote or container from being easily opened. The apparatus may be made of any suitable material, including, but not limited to, plastic.

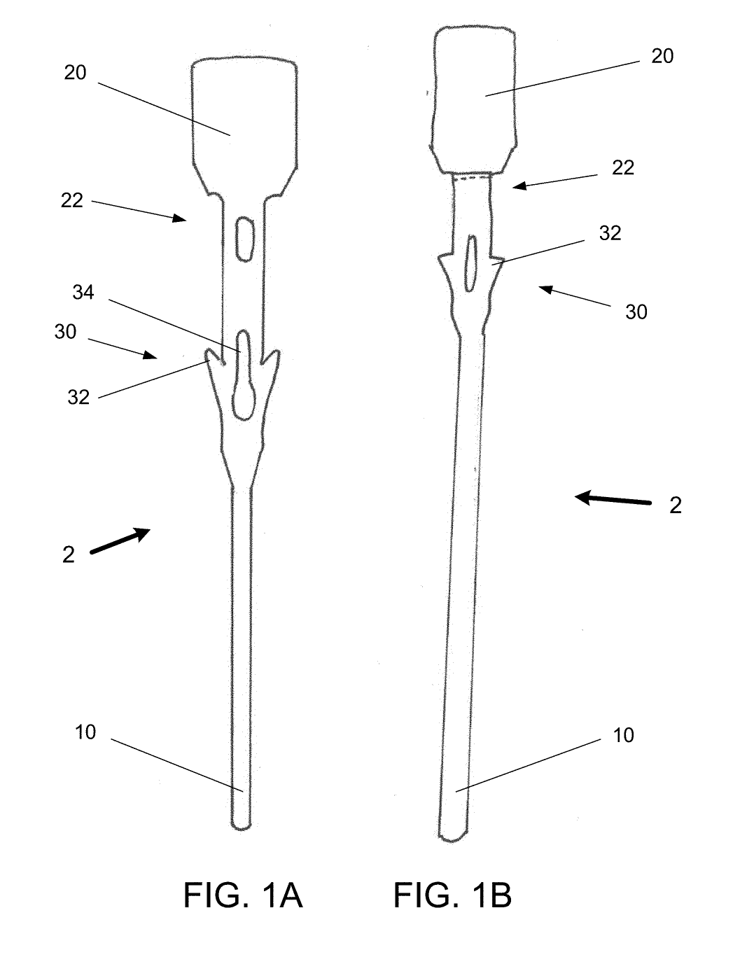

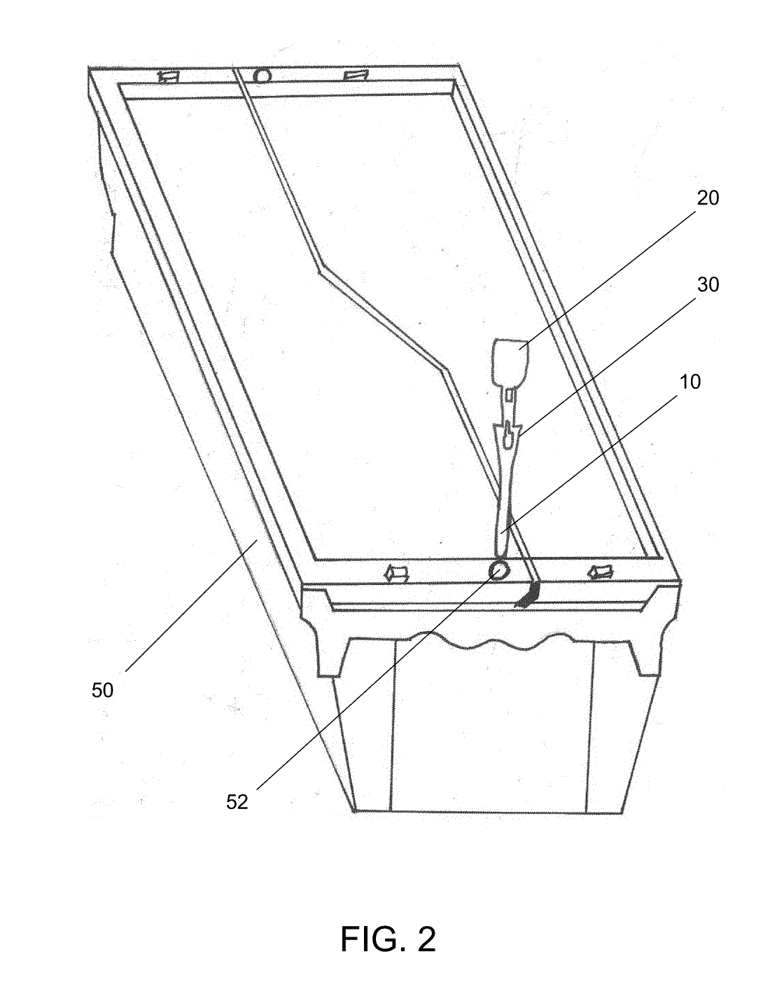

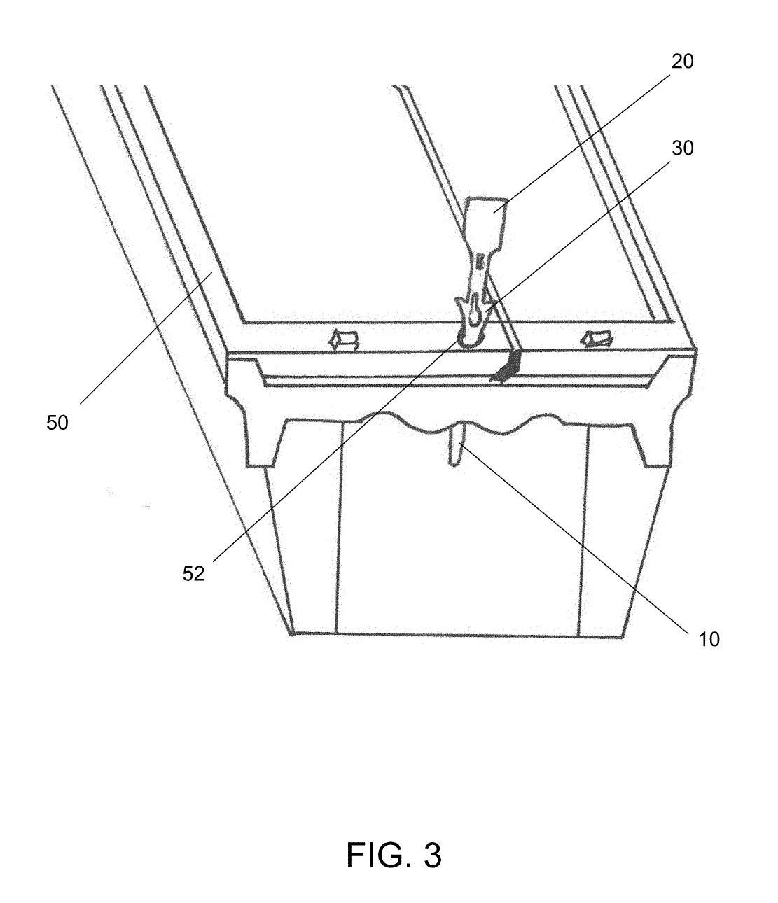

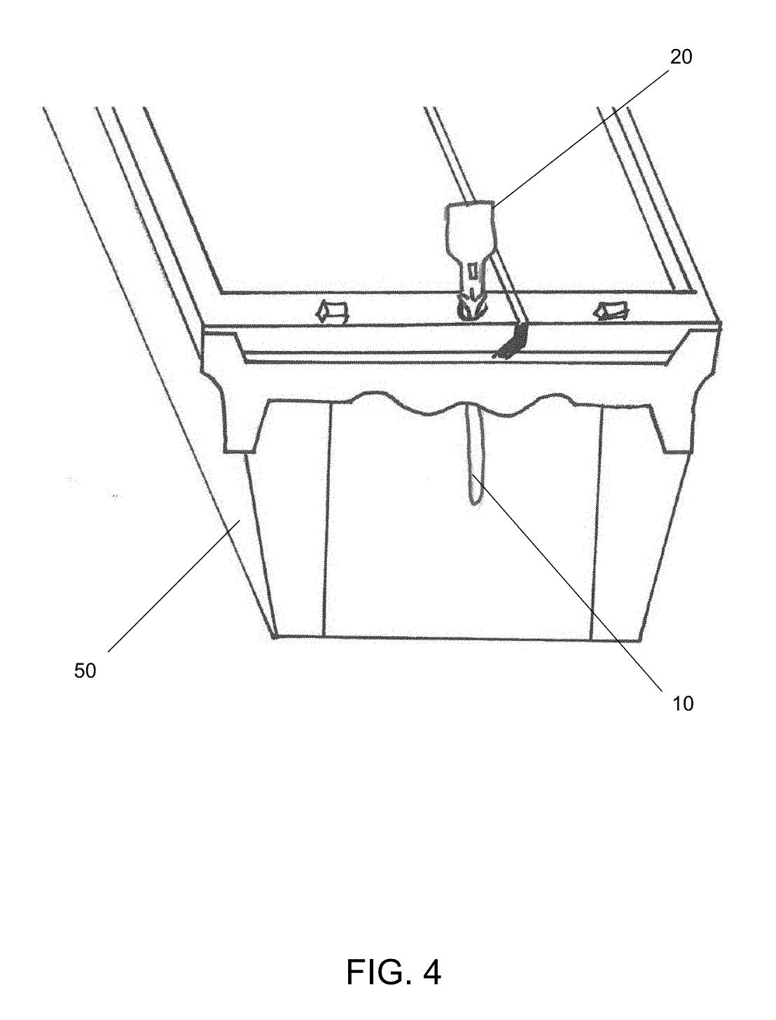

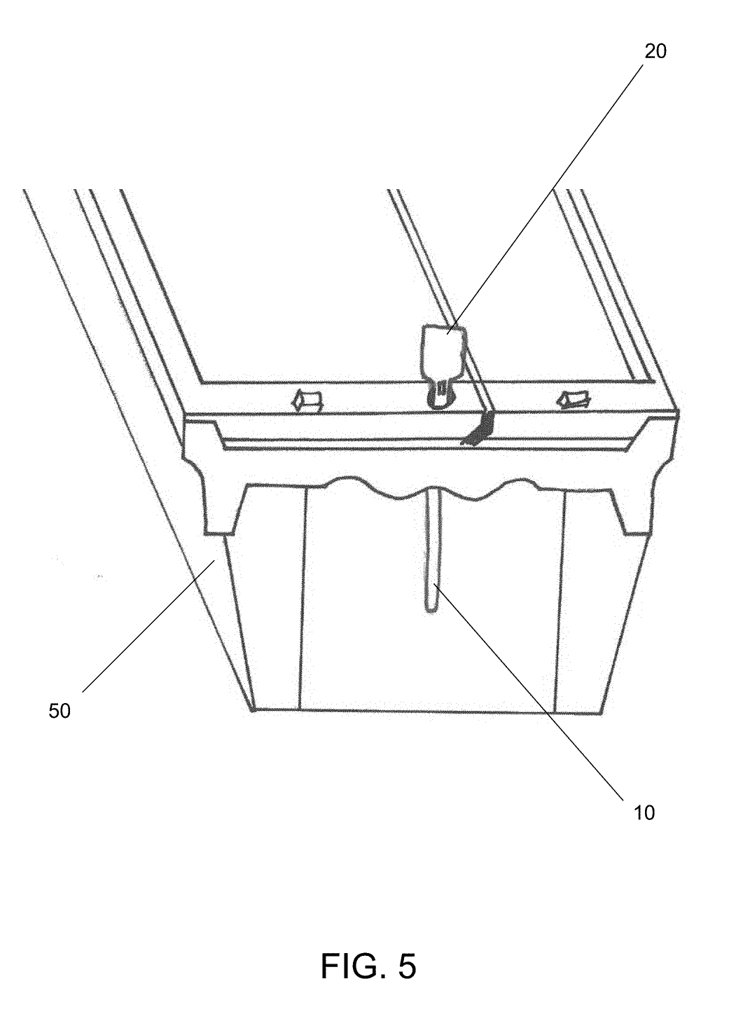

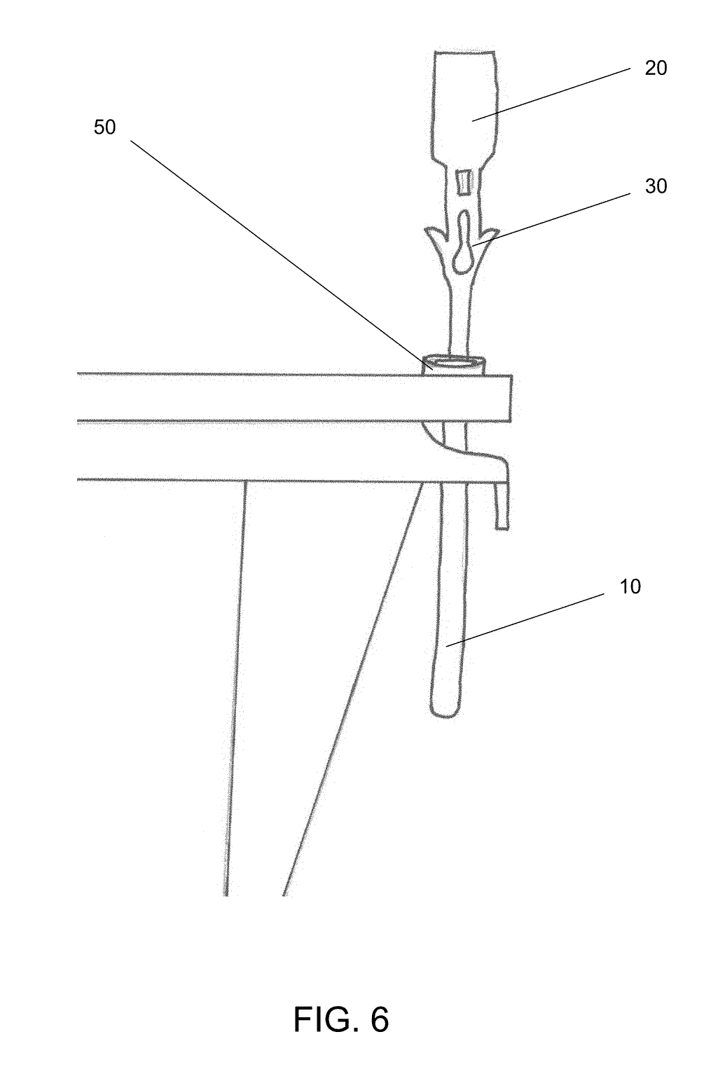

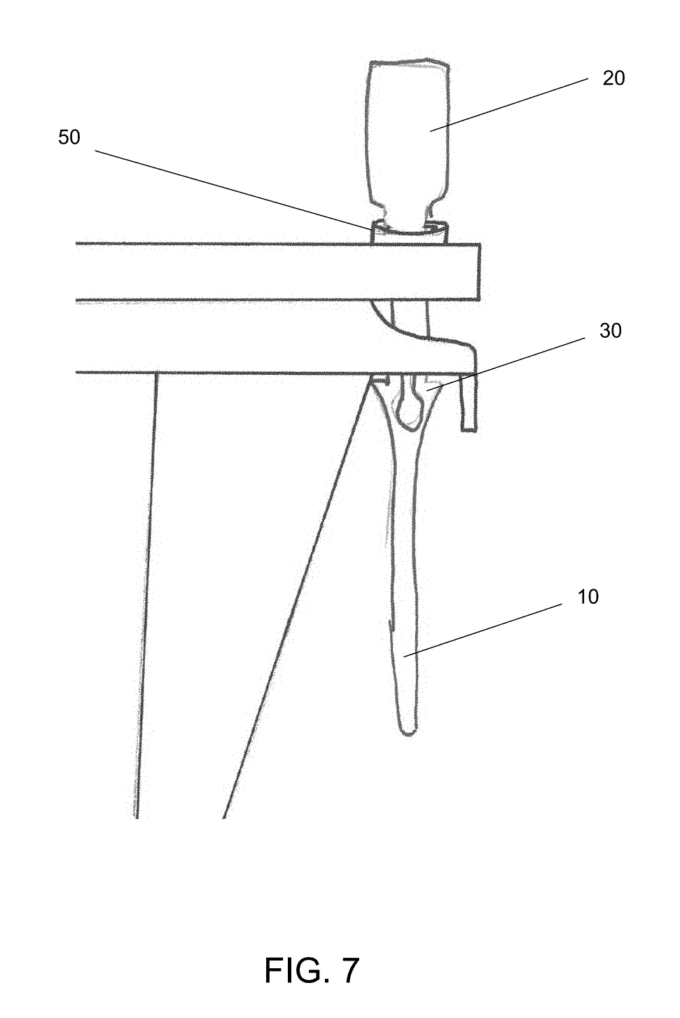

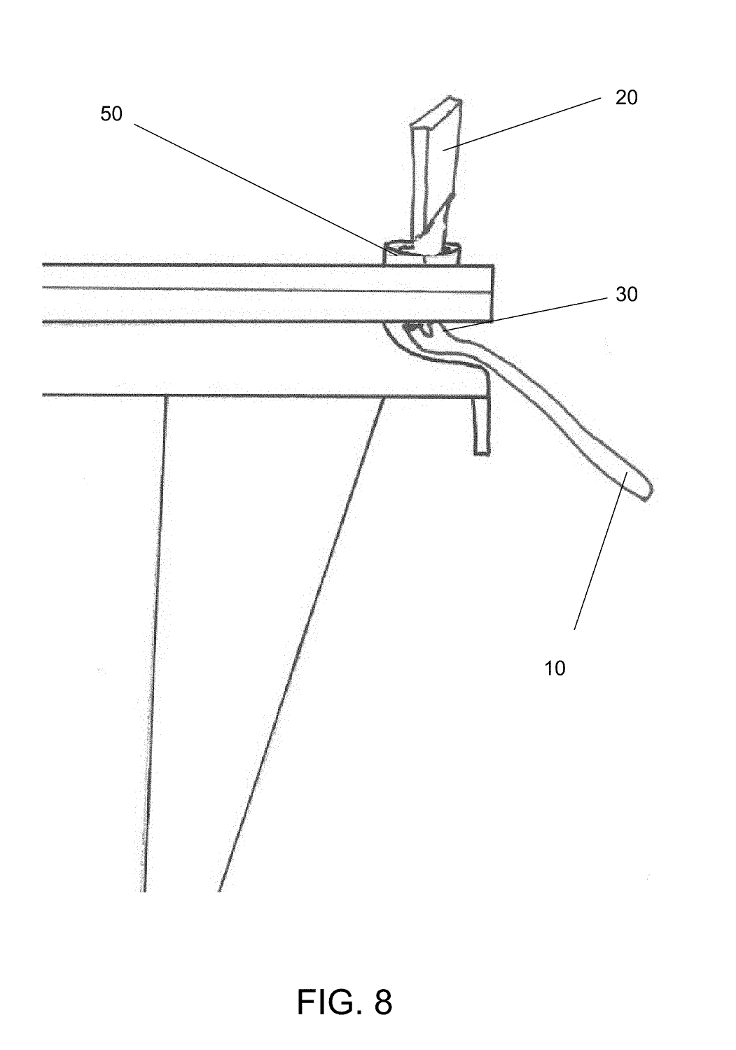

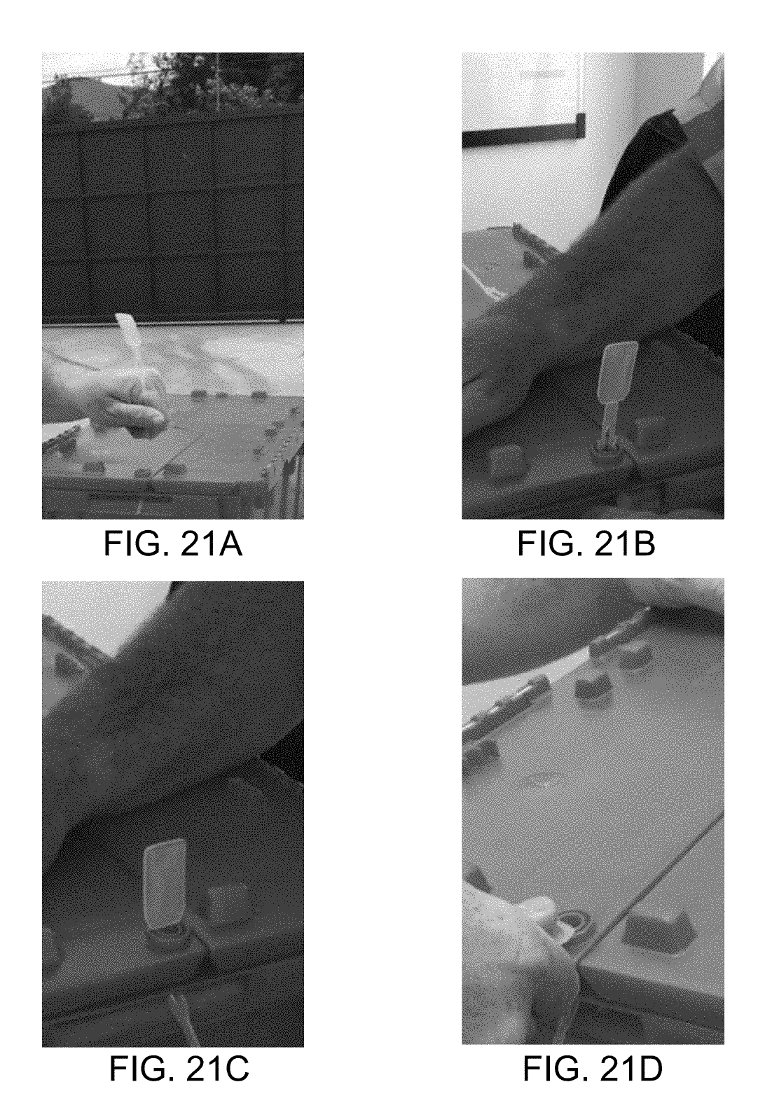

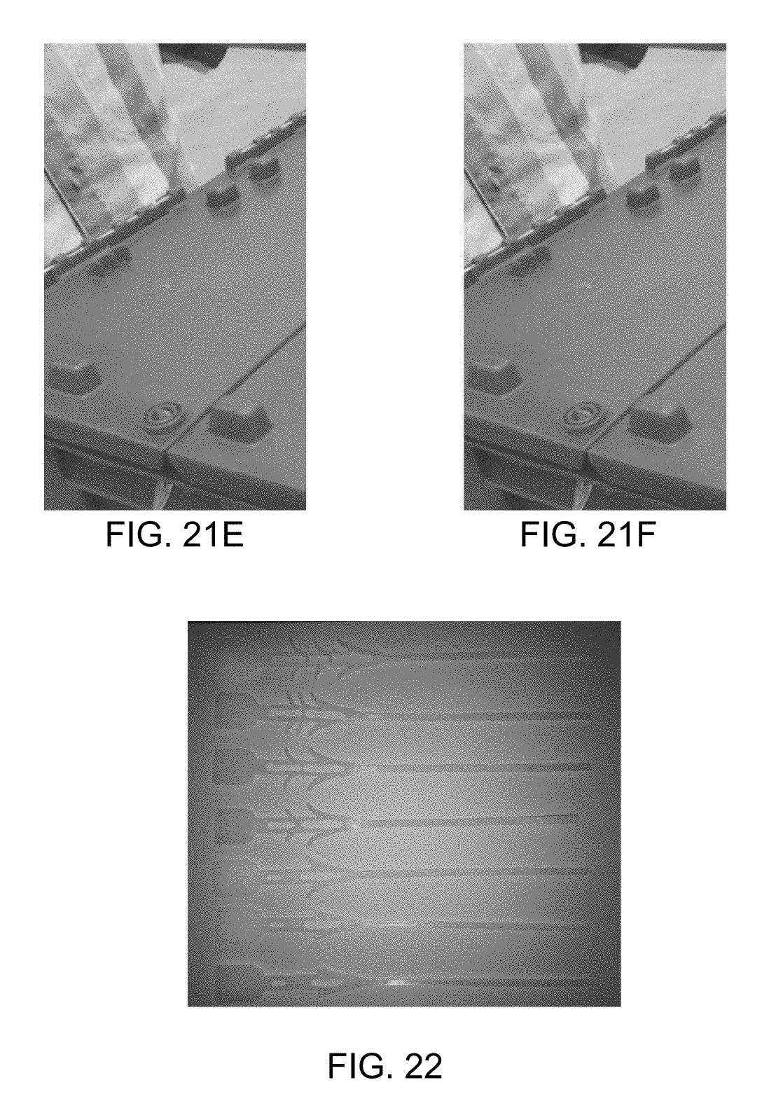

As seen in FIGS. 1A and 1B, in several exemplary embodiments the apparatus comprises an elongated plastic strip with an insertion or pull end 10, a stop tab end 20, and a compression locking element 30 medially disposed therebetween. The insertion end is inserted into and through the matching holes or slots 52, and then used to pull the compression locking element through the holes or slots, as seen in FIGS. 2-7. The stop tab end prevents the apparatus from continuing to be pulled through the holes or slots. Once through, the configuration of the compression locking element prevents the apparatus from being pulled back through the holes or slots in reverse, thereby securing the top or lid, or portion of the top or lid, to the body (e.g., side or rim) of the container or tote. In several embodiments, two locking strips are used to secure the tote or container, one at either end of the top or lid. To open the container by removing the strip (or strips), the stop tab is removed from each strip, e.g., twisted off, torn off, cut off, or the like (see FIGS. 21A-F for the process of insertion and removal).

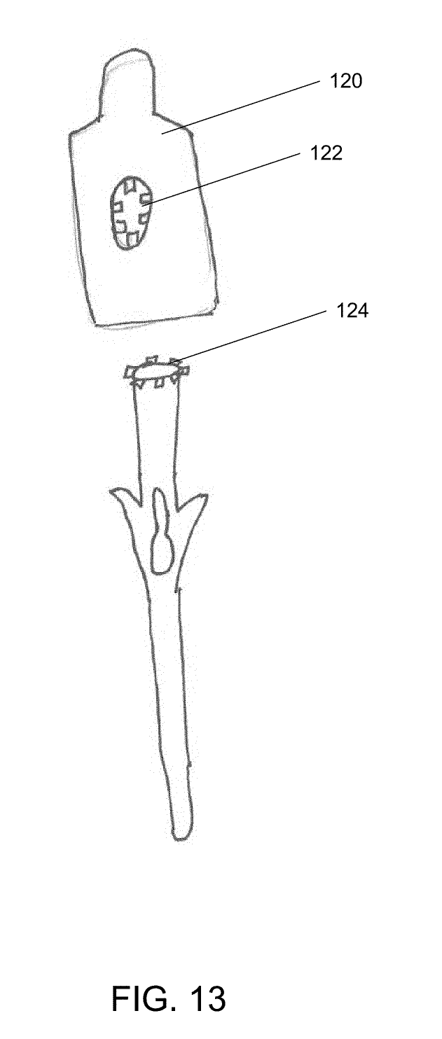

The stop tab element 20 provides various levels of safety tamper-evidence security (e.g., the breaking of the apparatus by removal of the stop tab demonstrates that the container or tote has been potentially opened), depending on the application. For light duty applications, the stop tab can be broken off or twisted off easily. The section 22 of the strip proximate the stop tab may be perforated, have one or more holes therein, or be thinner in thickness or width, or combinations thereof, to facilitate removal. The stop tab also may be independent of the remaining components of the apparatus (as opposed to be integrated therewith), and attachable and detachable, as seen in FIG. 13. For heavier duty applications, or applications that require a higher level of security, the stop tab and adjacent strip may be thickened, making it increasingly harder to remove the stop tab, or requiring the apparatus to be cut.

In several embodiments, the compression locking element 30 comprises one or more angled extensions (or “hooks”) 32 from the sides, with an elongated opening 34 therebetween. This configuration allows the angled extensions to be pushed inwards when passing through the holes or openings, and expand outwards when completely pulled through. The angled extensions are angled to promote the compression when passing through, and to prevent pulling of the apparatus through the holes or openings in reverse.

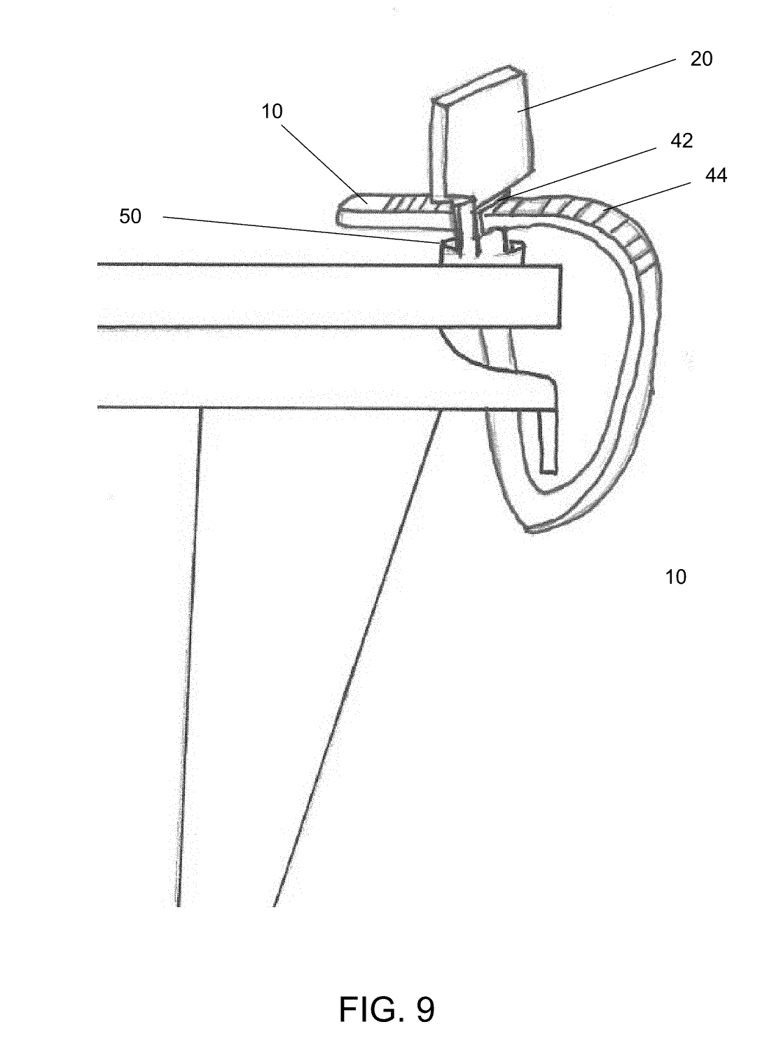

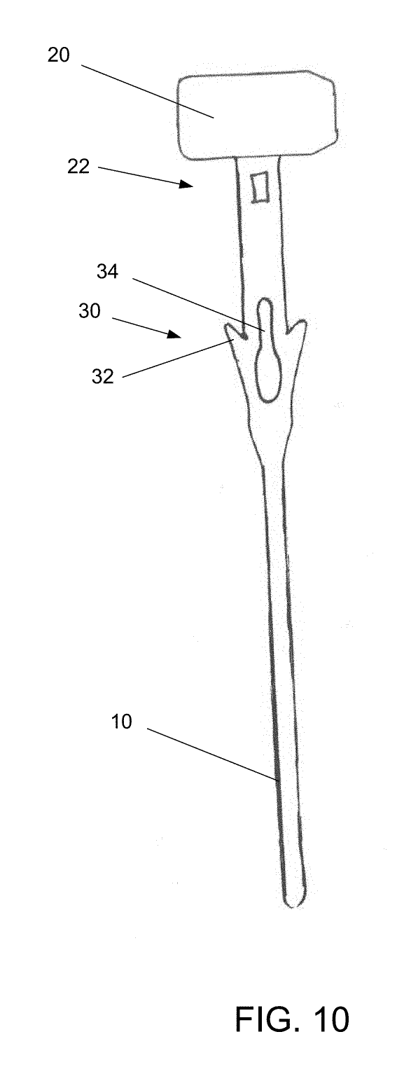

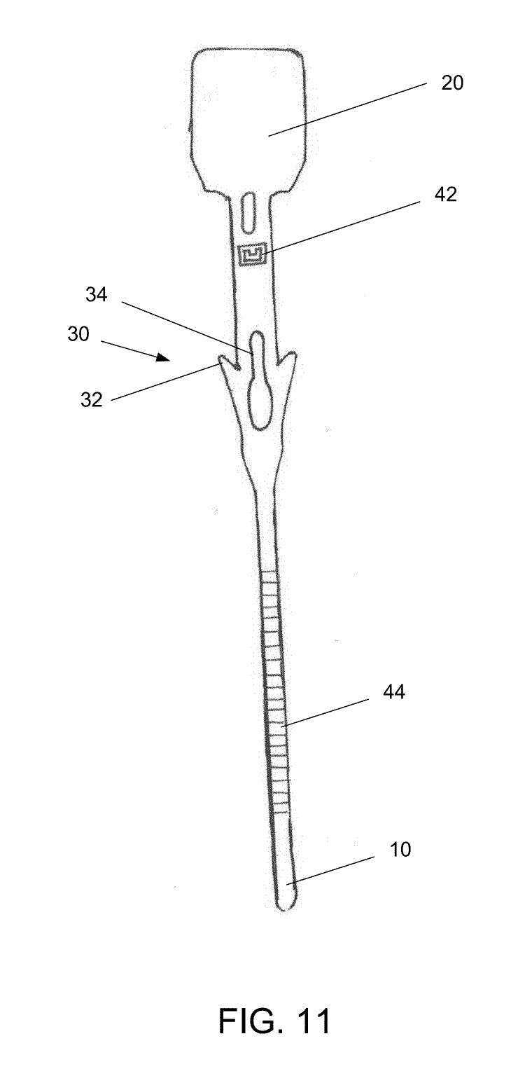

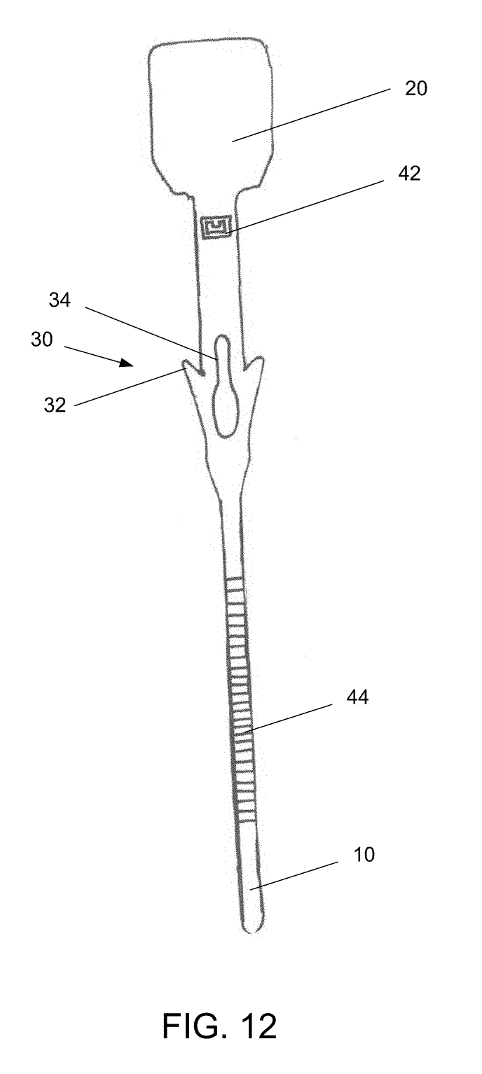

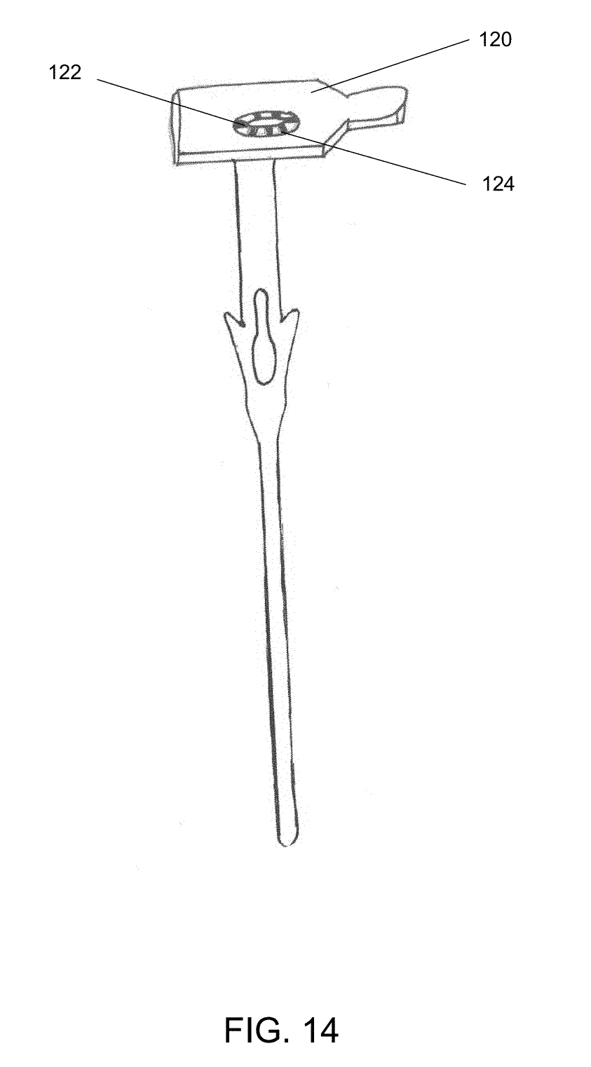

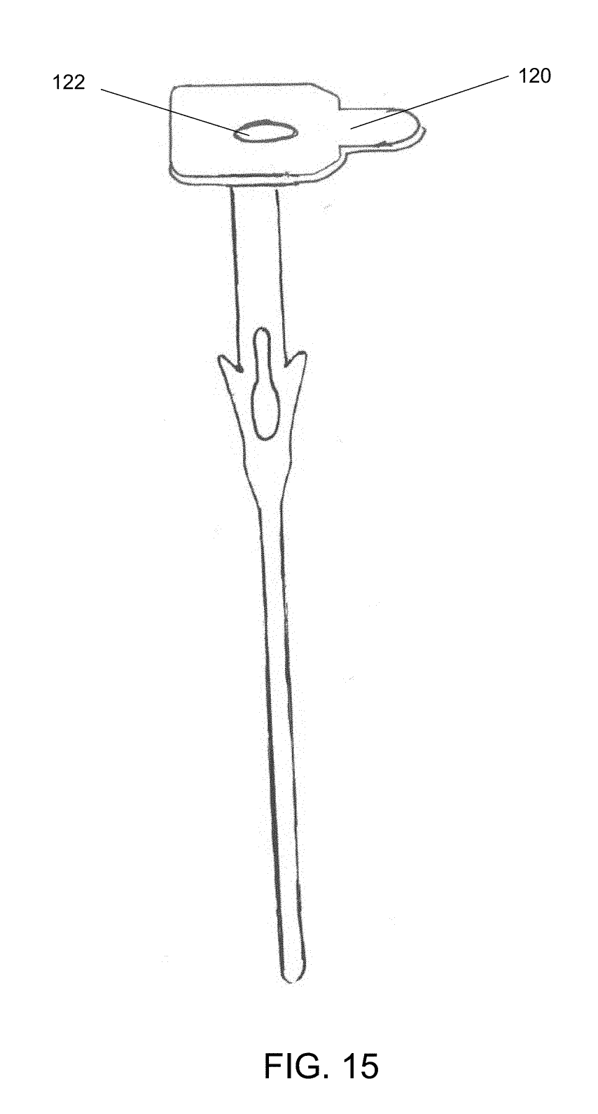

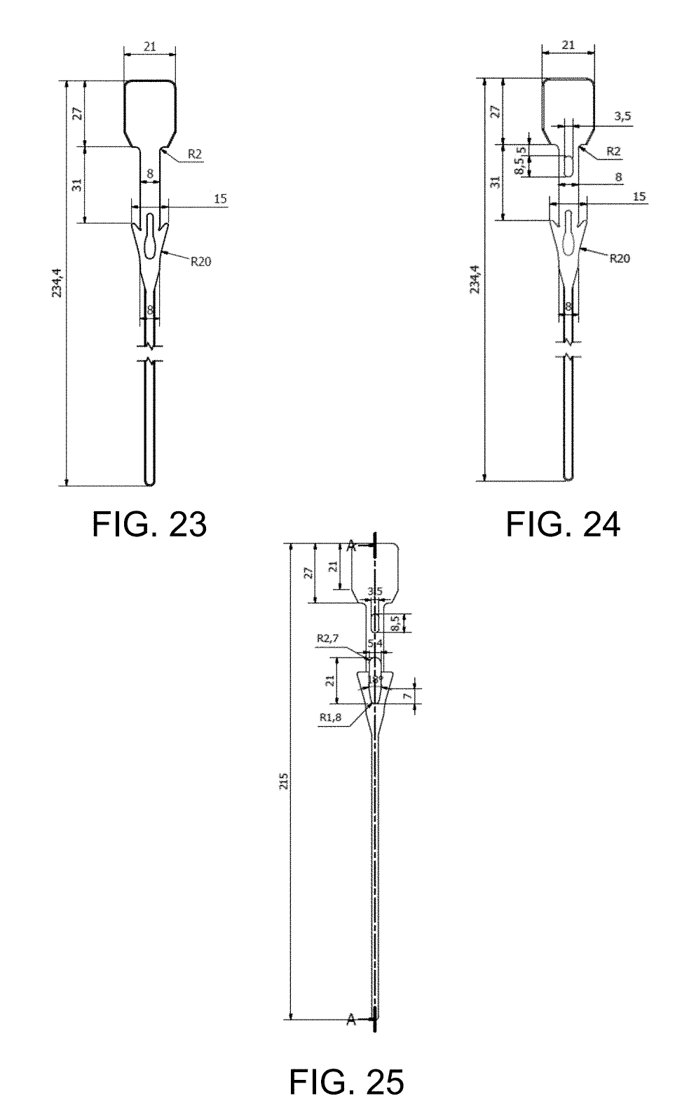

Various additional configurations of the locking element are shown in FIGS. 10-25. In some exemplary embodiments, a “zip-tie” receiving element (or grooved hole or opening) 42 may be positioned on or near the stop-tab end, while the insertion end may be laterally grooved 44. After insertion of the apparatus, the insertion end may be routed back and through the zip-tie receiving element for additional security, as seen in FIGS. 9 and 11-12.

FIGS. 13-15 show an exemplary embodiment with a detachable or removable stop tab end 120. A hole with teeth or tabs 122 is located in the body of the stop tab end 120, and receives the top 124 of the lower portion of the strip, which has matching teeth or tabs or other means to engage and connect to the stop tab end.

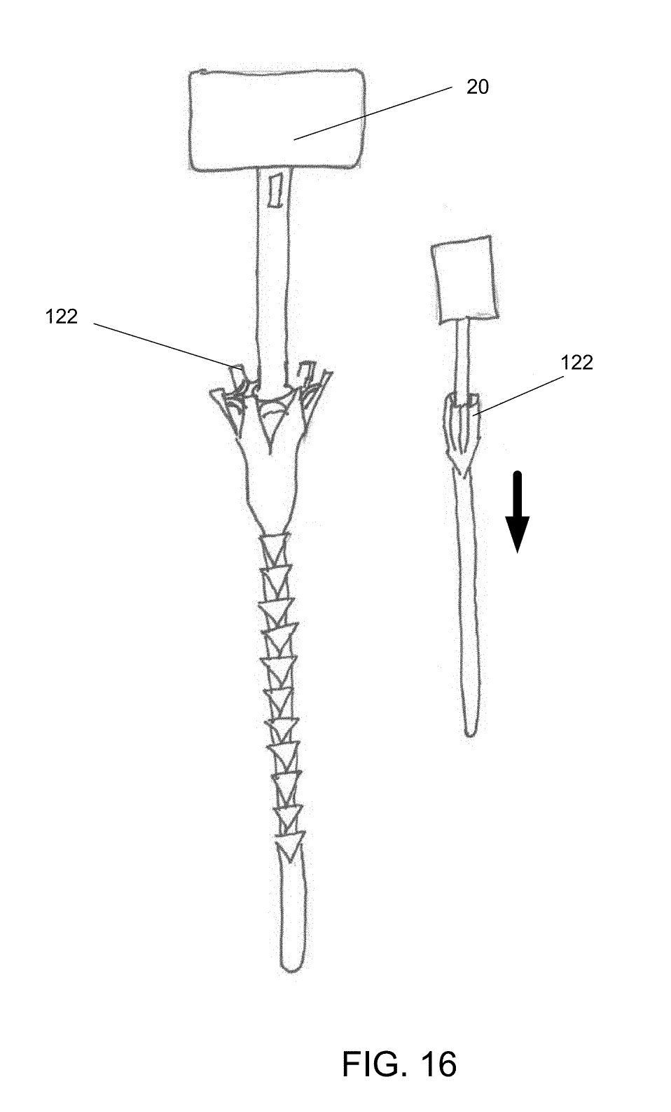

FIG. 16 shows an alternative embodiment of a “three-dimensional” compression locking element comprising several angled extensions 132 extending circumferentially from the strip, which are forced closed when the strip is pulled with downward force.

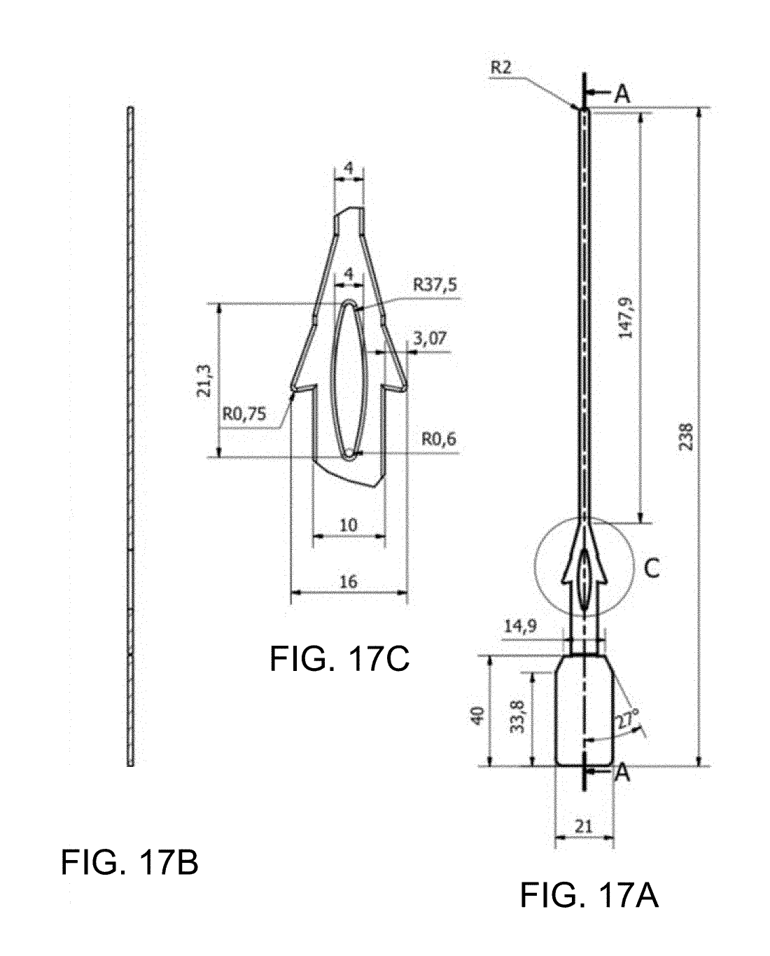

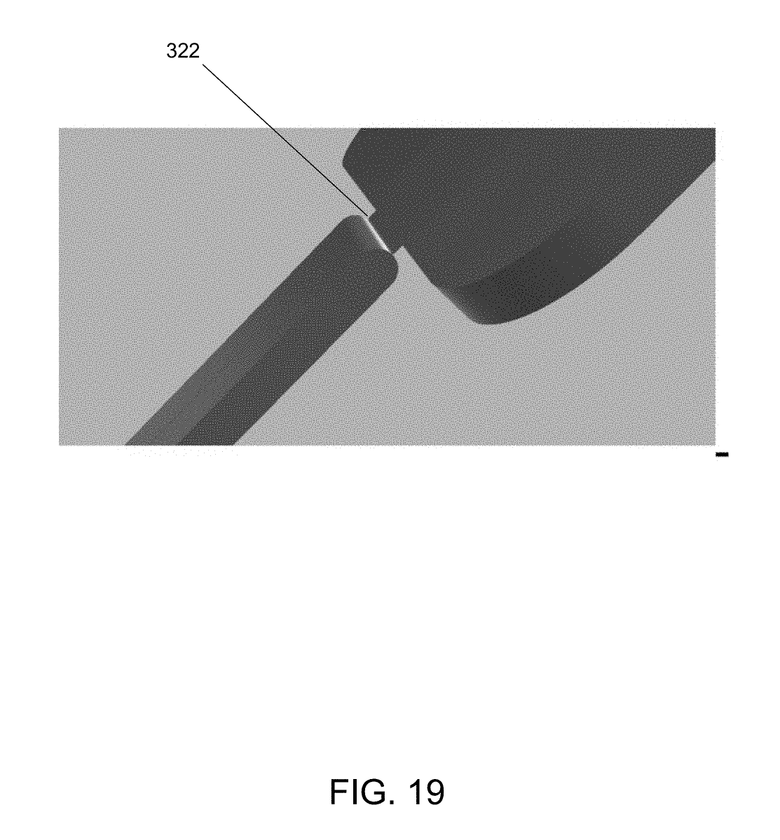

FIG. 17A another embodiment of a locking strip apparatus. FIG. 17B shows a side view of FIG. 17A, while FIG. 17C shows a close-up view of the compression locking element. FIG. 19 shows a close up view of an example of a thin connection 322 between the lower part of the locking strip and the

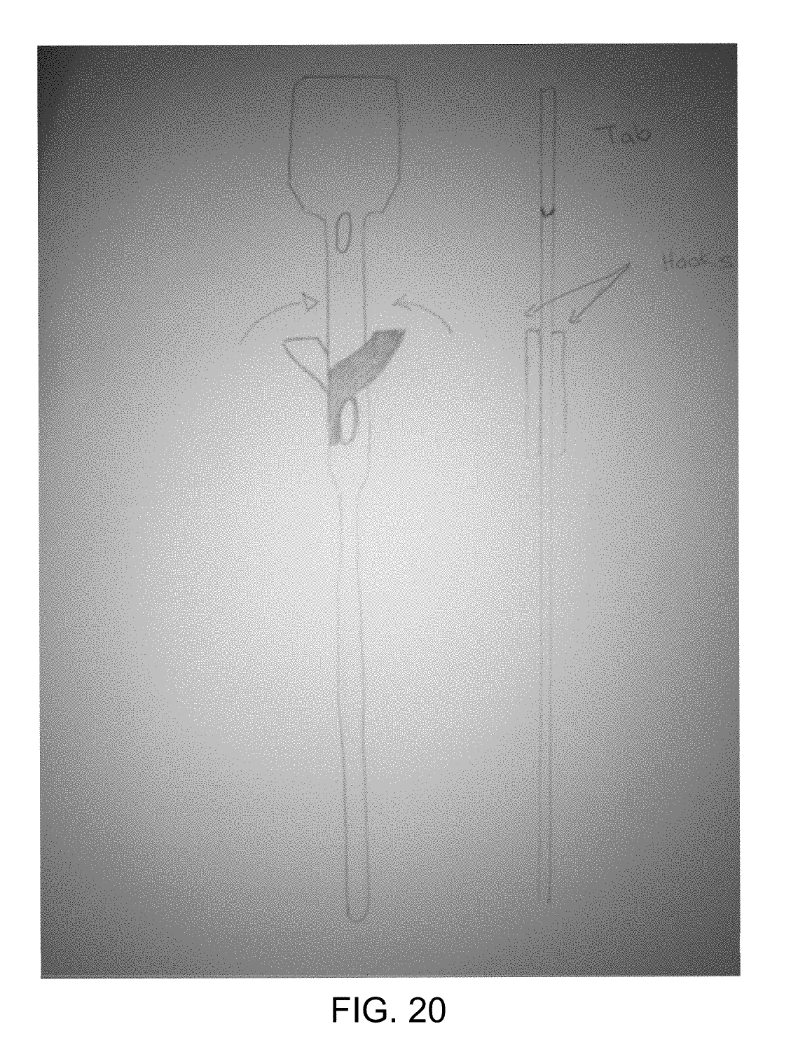

In one embodiment, as seen in FIG. 20, the angled extensions are attached on the opposing flat sides of the unit, and pivot due to the flexibility of the plastic when compressed (i.e., when pulled through the openings).

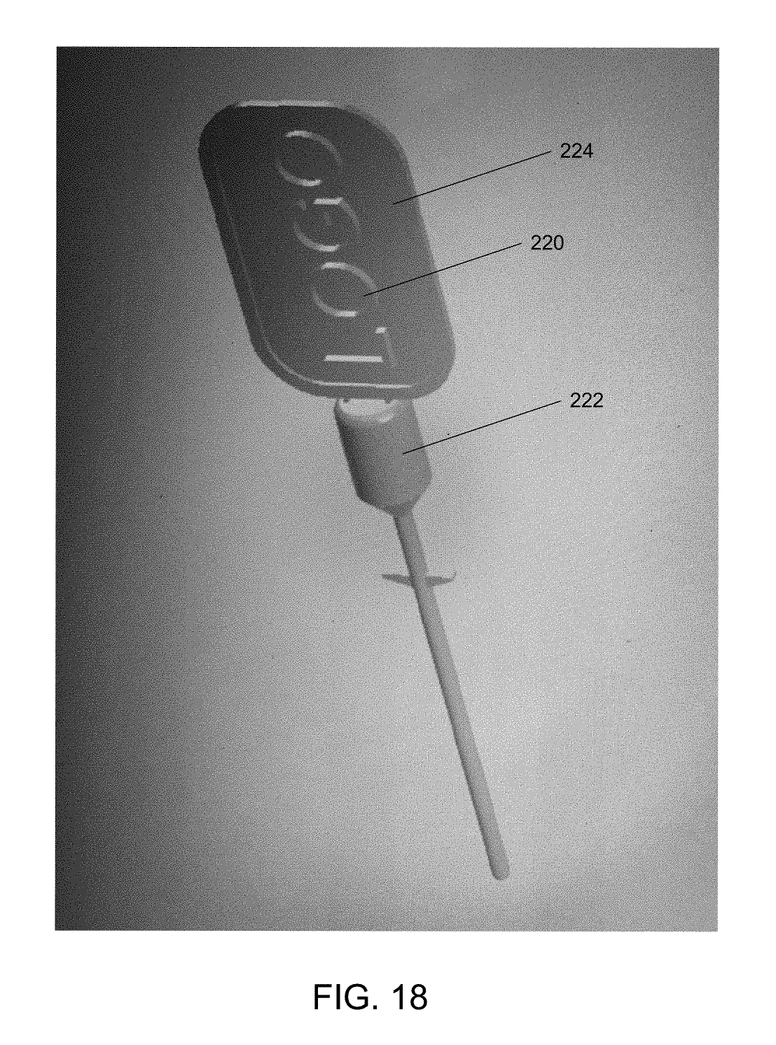

In several embodiments, the stop tab may be moved or bent to various angles, depending on the application. The stop tab may have imprinted or written information, logos 220 (as seen in FIG. 18), or security numbering thereon, or may have adhesive labels or stickers attached thereto. As seen in FIG. 18, the stop tab element may comprise a stop tab base 222 with a removable, interchangeable stop tab element 224 removably attached thereto.

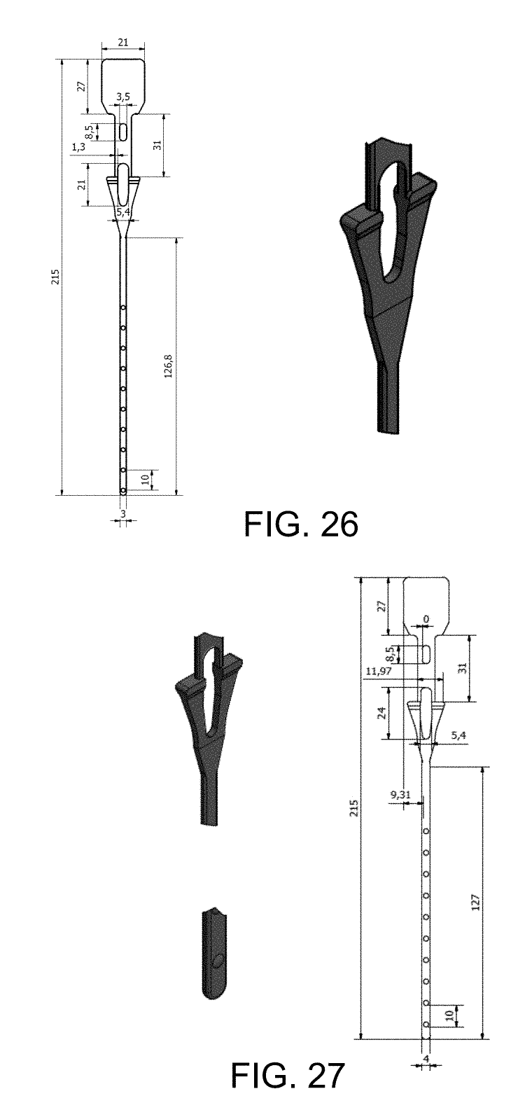

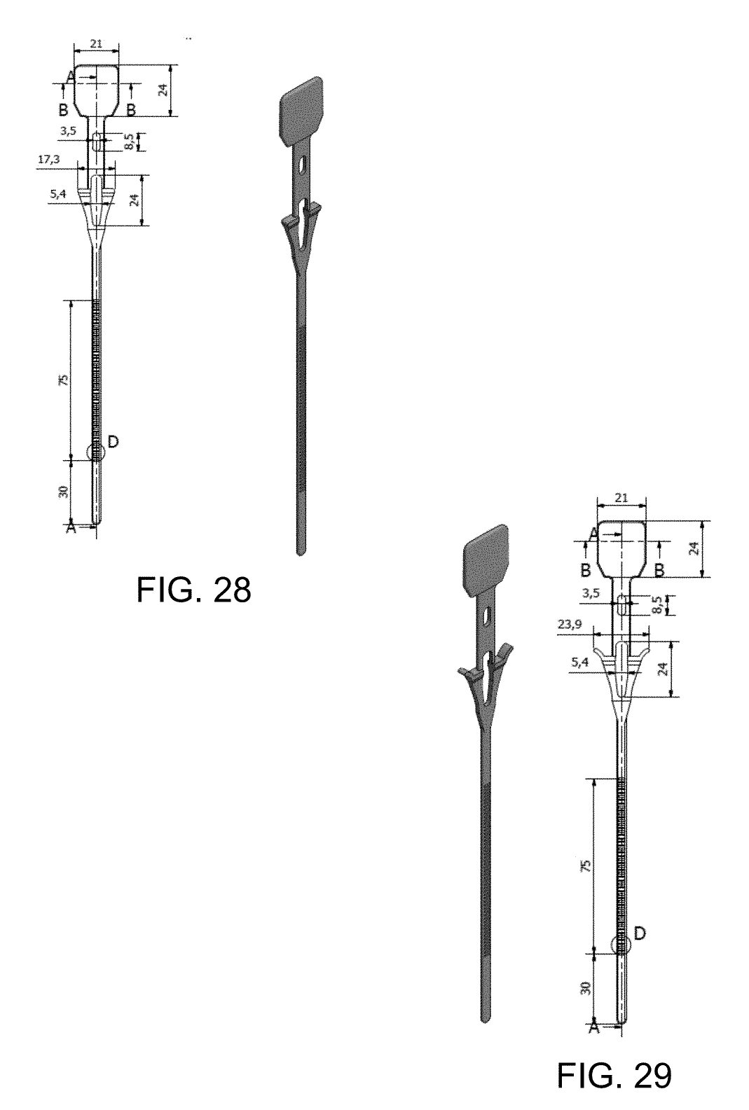

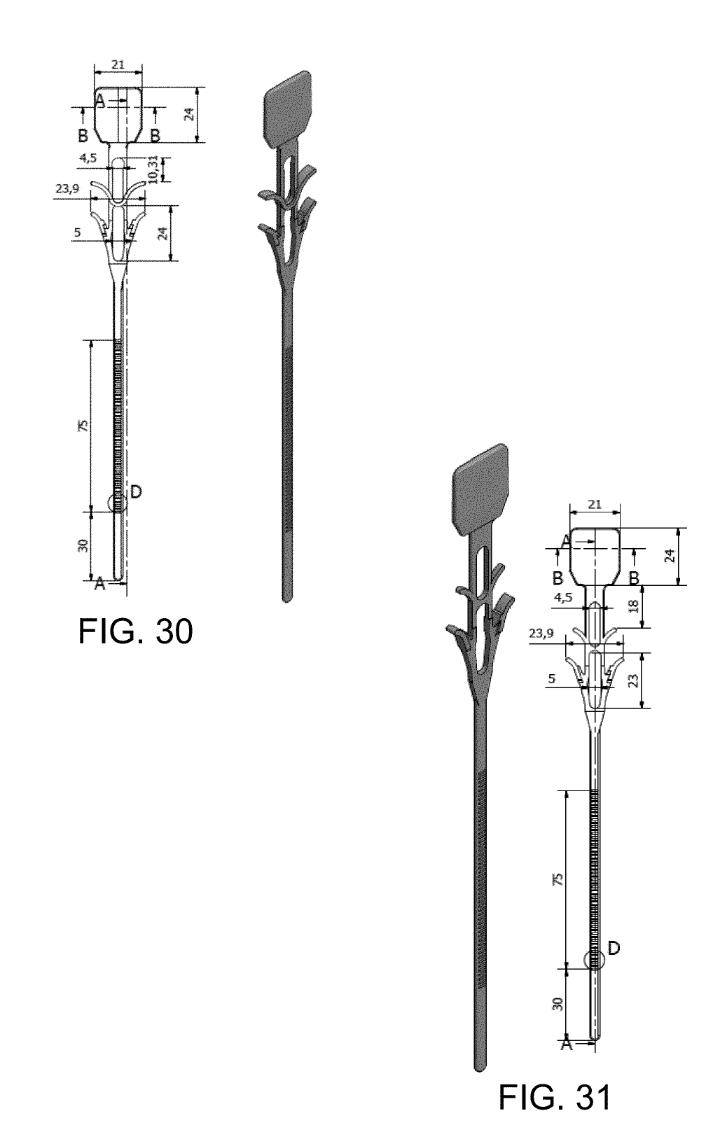

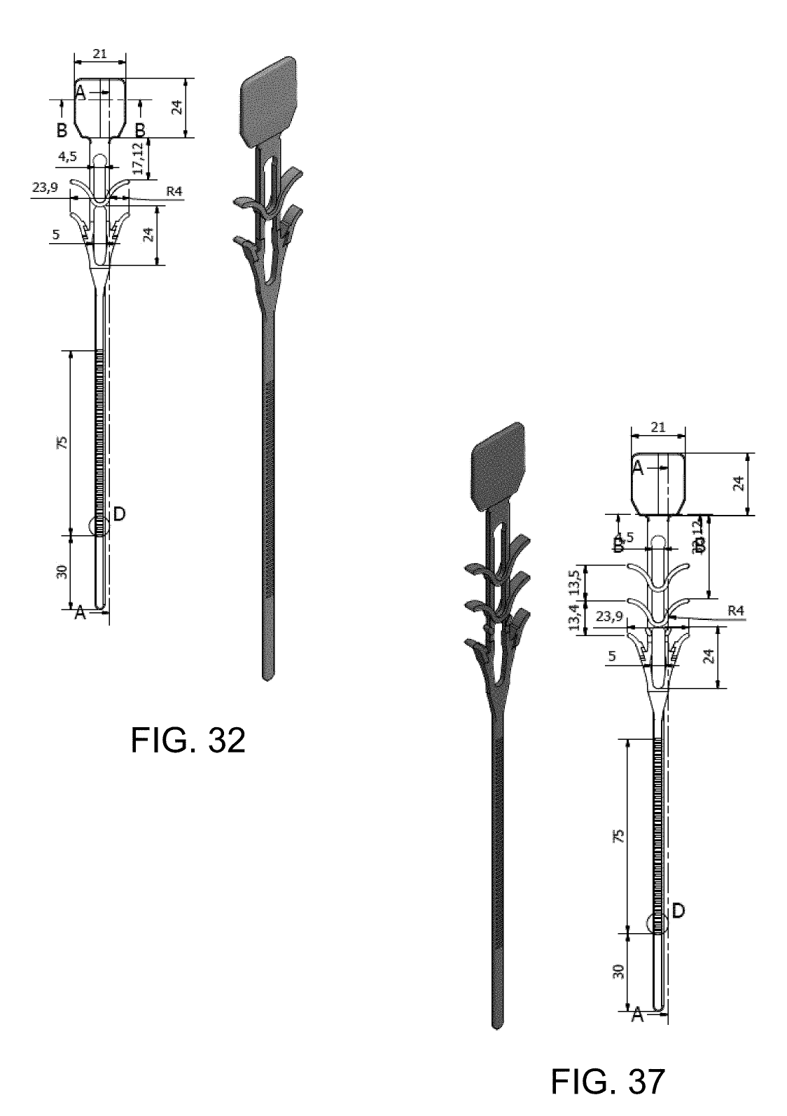

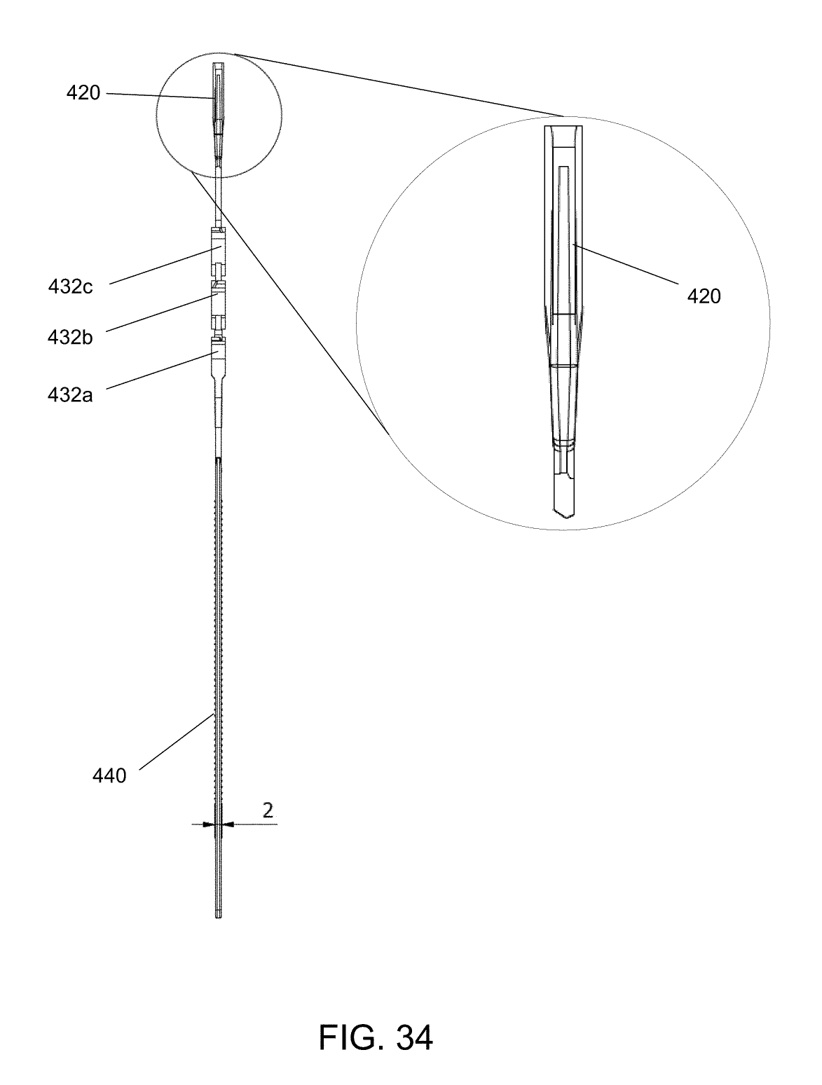

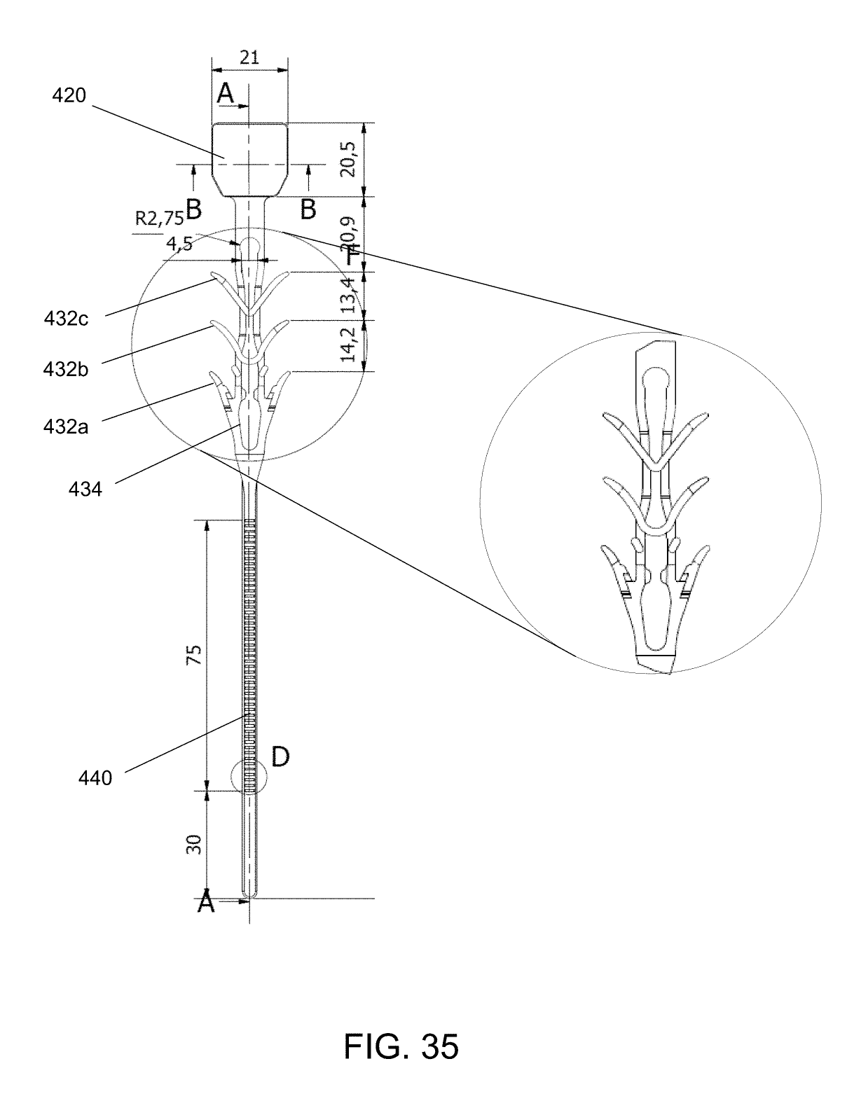

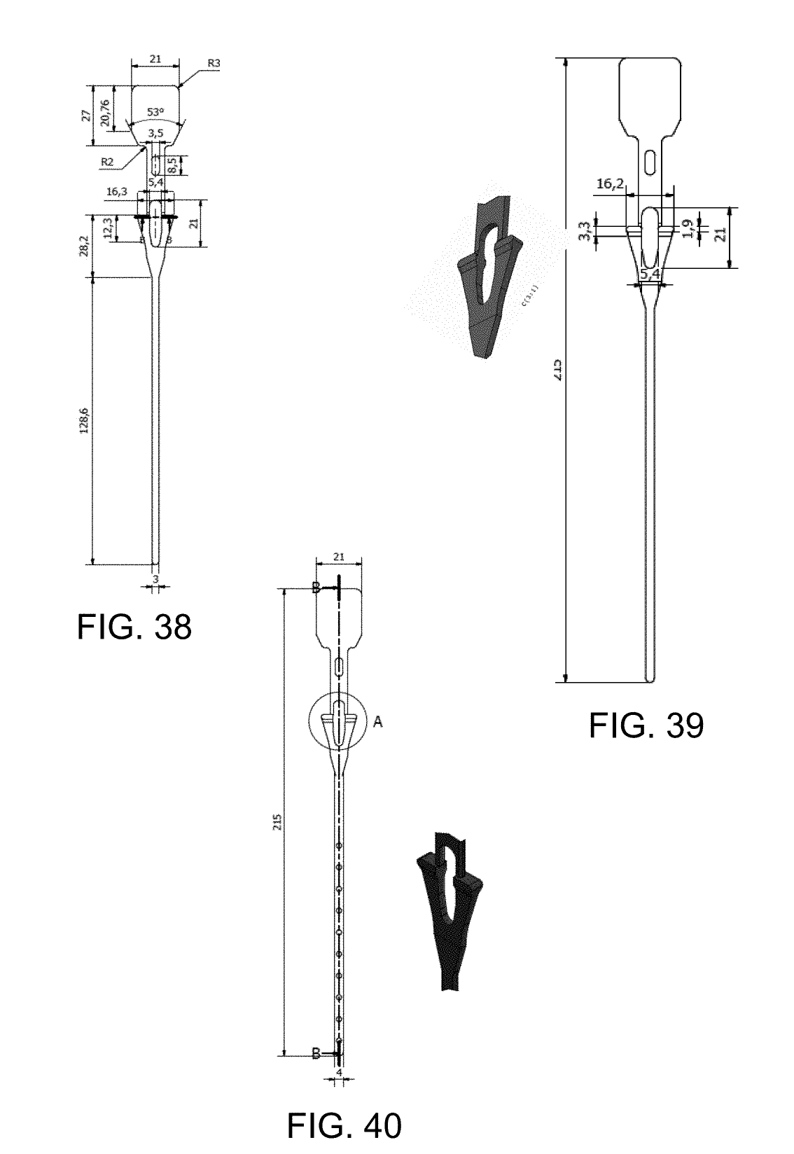

Additional configurations of the locking element are shown in FIGS. 22-40. These configurations include two or three angled extensions from each side, with and without a support extending between corresponding extension across the elongated opening (i.e., sub-dividing the opening into two or three sub-openings). The additional extensions provide enhanced security to prevent the container from opening. In particular, for certain container configurations, the different levels of extensions may separately engage different elements of the container top and sides. In another configuration, the extensions are thicker and more triangular in shape or wedge-like, which also promotes enhanced security.

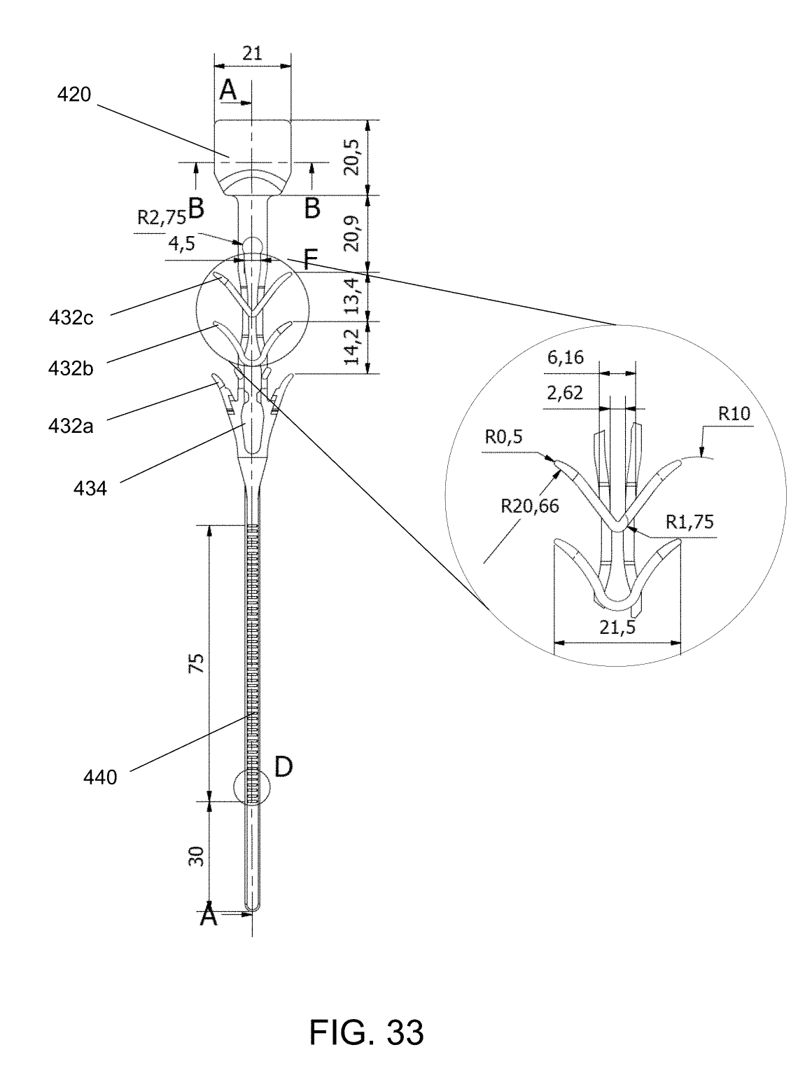

FIGS. 33-36 show two examples of a locking strip with a stop tab 420, a compression locking element with three sets of angled extensions or hooks 432a, b, c extending across the main opening 434. The sets of angled extensions provide additional security (i.e., if an upper set fails or breaks, a lower set can still hold the lid or top of the tote in place). The different distances for each set also allow different thickness of lids and tote tops to be accommodated (i.e., a thicker combination of lid and tote top may only be pulled through as far as the lowermost set of angled extensions, while the higher sets of angled extensions can be used to secure thinner combinations of lid and tote tote). A series of ridges, indentations, raised elements, or other patterned surface features 440 may be provided on one or both sides of the all or part of the insertion section of the locking strip. Among other benefits, these ridges can assist in pulling a strip through the corresponding holes in the lid and tote top.

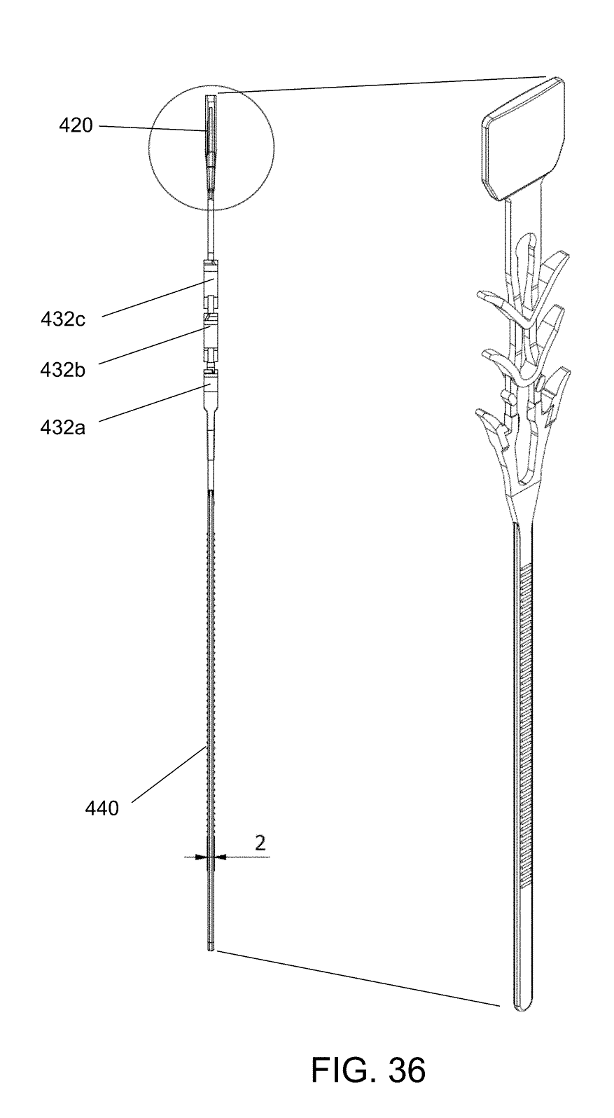

As can be seen in the side views (FIGS. 34 and 36), the locking strip is generally thinner in cross section. The insertion end and section between the compressing locking element and stop tab are the thinnest, with the stop tab itself being thicker, and the angled extensions being thickest.

The apparatus effectively traps the container lid between the tab and the compression locking element. The distance between the compressing locking element and the stop tab, the length and width of the angled elements, and the length of the apparatus, along with other dimensions of the apparatus, may be adjusted to fit a variety of totes or containers, as seen in the various figures. The apparatus may be using with various shipping or storage totes, bins, or containers of various types, or other devices where restraint ports or the like are provided.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. An apparatus for securing shipping and storage totes and containers, comprising:
an elongated strip with a first end and a second end,
the first end comprising an insertion end, configured to be inserted and pass through a first hole or slot in a lid or top of a tote or container, and a second hole or slot in a side or rim of the tote or container;
the second end comprising a stop tab end, configured to not be able to pass through the first hole or slot or the second hole or slot; and
a compression locking element disposed on the elongated strip between the first end and second end, said compression locking element comprising at least one angled extension configured to pass through the first hole or slot and the second hole or slot in a direction towards the first end, but resist passing through the first hole or slot or second hole or slot in a direction towards the second end.

2. The apparatus of claim 1, wherein the compression locking element comprises two angled extensions on opposing sides of the elongated strip.

3. The apparatus of claim 2, wherein the compression locking element comprises at least one hole or opening in the elongated strip between the two angled extensions.

4. The apparatus of claim 1, wherein the compression locking element comprises one or more pairs of angled extensions on opposing sides of the elongated strip.

5. The apparatus of claim 1, wherein there are two pairs of angled extensions.

6. The apparatus of claim 1, wherein there are three pairs of angled extensions.

7. The apparatus of claim 1, wherein each pair of angled extensions is at a different distance from the second end.

8. The apparatus of claim 1, wherein the stop tab end comprises a stop tab.

9. The apparatus of claim 8, wherein the stop tab is removable by cutting.

10. The apparatus of claim 8, wherein the stop tab is removable by twisting.

11. The apparatus of claim 8, wherein the stop tab is the widest section of the elongated strip.

12. The apparatus of claim 8, further comprising a plurality of grooves, indentations, ridges or raised elements are disposed on one or more sides of the elongated strip between the insertion end and compression locking element.

13. A method of securing a shipping or storage tote or container with a lid, comprising:
providing an elongated locking strip with an insertion end, a stop tab end, and a compression locking element disposed therebetween;
inserting the insertion end into a first hole in a lid of a tote or container and a second hole in a side or rim of the tote or container;
pulling the insertion end of the elongated locking strip so the compression locking element passes through the first hole and the second hole to a point where the compression locking element resists passing through the first or second hole in the opposite direction.

14. The method of claim 13, wherein the compression locking element comprises two angled extensions on opposing sides of the elongated strip.

15. The method of claim 13, wherein the compression locking element comprises at least one hole or opening in the elongated strip between the two angled extensions.

16. The method of claim 13, wherein the compression locking element comprises one or more pairs of angled extensions on opposing sides of the elongated strip.

17. The method of claim 13, wherein the stop tab end is too large to pass through the first or second hole.

18. The method of claim 17, further comprising the steps of:
detaching the stop tab end from the elongated locking strip; and
pulling the elongated locking strip out of the first and second holes.

19. The method of claim 18, wherein the step of detaching comprises cutting the stop tab end off of the elongated locking strip.

20. The method of claim 18, wherein the step of detaching comprises twisting the stop tab end off of the elongated locking strip.
